(19) United States
(12) Patent Application Publication
(10) Pub. No.: US 2026/0086208 A1
(43) Pub. Date: Mar. 26, 2026

(54) ROTATING DEVICE OF POLYGONAL MIRROR, AND LIDAR

(71) Applicant: AUTOX TECH PTE. LTD., SINGAPORE (SG)

(72) Inventors: Jianxiong Xiao, Shenzhen (CN); Qiang Yu, Shenzhen (CN); Zhuo Li, Shenzhen (CN)

(73) Assignee: AUTOX TECH PTE. LTD., SINGAPORE (SG)

(21) Appl. No.: 19/256,615

(22) Filed: Jul. 1, 2025

(30) Foreign Application Priority Data
Sep. 24, 2024 (CN) 2024113421394

(51) Int. Cl. G01S 7/481

(52) U.S. Cl. CPC G01S 7/4817

(57) ABSTRACT

Disclosed are a rotating device of a polygonal mirror, and a lidar, the rotating device includes a bearing support, a motor, and the polygonal mirror, the bearing support includes a first bearing support and a second bearing support; the motor is connected to a surface of the first bearing support facing toward the second bearing support, an end surface of the motor facing away from the first bearing support is provided with a motor rotor; the polygonal mirror includes a first end surface and a second end surface opposite to the first end surface, the first end surface is connected to the motor rotor through a plurality of connecting elements; a bearing is disposed between the first bearing support and the second bearing support, the motor rotor and the polygonal mirror are respectively sleeved on the bearing; the motor drives the motor rotor to rotate.

### CROSS REFERENCE TO RELATED APPLICATION

This non-provisional patent application claims priority under 35 U.S.C. § 119 from Chinese Patent Application No. 202411342139.4 filed on Sep. 24, 2024, the entire content of which is incorporated herein by reference.

### TECHNICAL FIELD The present application relates to the technical field of lidars, particularly to a rotating device of a polygonal mirror, and a lidar.

### BACKGROUND

A mechanical lidar often includes a polygonal mirror and corresponding rotating device thereof. Commonly available lidars on the market are either large in size with low rotational speed, or small in size with high rotational speed in terms of dimensions and rotational speed of the polygonal mirror. However, when attempting to achieve large size and high rotational speed of the polygonal mirror, excessive centrifugal force can easily cause damage to the polygonal mirror and rotating device thereof. Moreover, it is difficult to achieve good concentricity in the assembly of the motor and the polygonal mirror. Additionally, the polygonal mirror and rotating device thereof are prone to vibration and noise at high rotational speeds.

### SUMMARY

The present application provides a rotating device of a polygonal mirror, and a lidar, which reduce vibration and noise of the polygonal mirror at high rotational speeds, decrease centrifugal force thereof, and maintain good concentricity.

In a first aspect, the rotating device of polygonal mirror is applied to the lidar equipped with the polygonal mirror, the rotating device includes a bearing support, a motor, and the polygonal mirror, the bearing support includes a first bearing support and a second bearing support that oppositely arranged each other; the motor is connected to a surface of the first bearing support facing toward the second bearing support, an end surface of the motor facing away from the first bearing support is provided with a motor rotor; the polygonal mirror includes a first end surface, and a second end surface opposite to the first end surface, the first end surface is connected to the motor rotor through a plurality of connecting elements; a bearing is disposed between the first bearing support and the second bearing support, an end of the bearing is connected to the second bearing support, the other end thereof, passing through the second end surface and the first end surface, is connected to the motor, the motor rotor and the polygonal mirror are respectively sleeved on the bearing; the motor drives the motor rotor to rotate when operating, thereby driving the bearing to rotate and in turn causing the polygonal mirror to rotate around the bearing.

In a second aspect, the lidar provided includes the polygonal mirror, and the rotating device of the polygonal mirror, the rotating device is configured to enable the lidar to emit light beams to the outside through the polygonal mirror, the rotating device includes the bearing support, the motor, and the polygonal mirror, the bearing support includes the first bearing support and the second bearing support that oppositely arranged each other; the motor is connected to the surface of the first bearing support facing toward the second bearing support, the end surface of the motor facing away from the first bearing support is provided with the motor rotor; the polygonal mirror includes the first end surface, and the second end surface opposite to the first end surface, the first end surface is connected to the motor rotor through the plurality of connecting elements; the bearing is disposed between the first bearing support and the second bearing support, the end of the bearing is connected to the second bearing support, the other end thereof, passing through the second end surface and the first end surface, is connected to the motor, the motor rotor and the polygonal mirror are respectively sleeved on the bearing; the motor drives the motor rotor to rotate when operating, thereby driving the bearing to rotate and in turn causing the polygonal mirror to rotate around the bearing.

The rotating device and the lidar mentioned-above achieve connection between the polygonal mirror and the motor rotor through a plurality of connecting elements, which can reduce vibration and noise when the polygonal mirror rotates around the bearing. Moreover, by connecting the bearing to the bearing support and the motor, good concentricity between the motor and the polygonal mirror when the motor driving is ensured. Additionally, brackets capable of accommodating countercounterweight elements are respectively sleeved between two bearing supports and outside the bearing support to reduce the centrifugal force of the polygonal mirror and the rotating device thereof.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a schematic structural diagram of a rotating device of a polygonal mirror.

FIG. 2 illustrates a schematic structural diagram of a lidar.

The realization of the purpose, functional characteristics and advantages of the disclosure will be further explained by referring to the attached drawings.

### DETAILED DESCRIPTION OF THE EMBODIMENTS

In order to make the purpose, technical solution and advantages of the invention more clearly, the invention is further described in detail in combination with the drawings and embodiments. It is understood that the specific embodiments described herein are used only to explain the invention and are not configured to define it. On the basis of the embodiments in the invention, all other embodiments obtained by ordinary technicians in this field without any creative effort are covered by the protection of the invention.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the invention are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the invention.

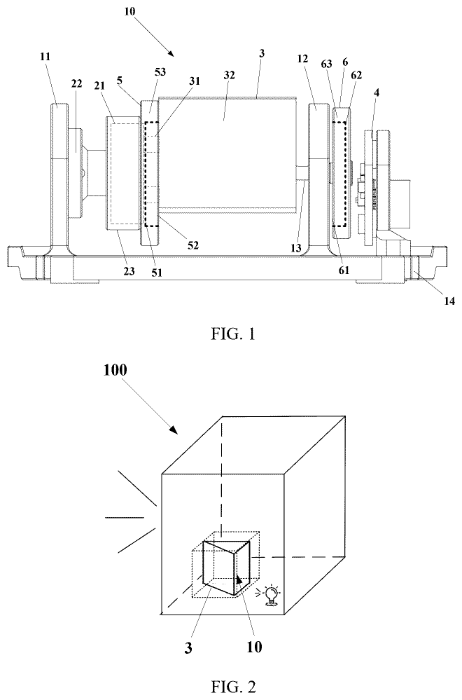

Refer to FIG. 1, a schematic structural diagram of a rotating device of a polygonal mirror is illustrated in FIG. 1. A rotating device 10 of a polygonal mirror 3 provided is applied to a lidar with the polygonal mirror 3. The lidar emits light beams to the outside through the polygonal mirror 3 to achieve multi-field-of-view scanning of the external environment that needs to be sensed by the lidar. The rotating device 10 provided can reduce the centrifugal force generated by the polygonal mirror 3 during rotation and reduce the vibration and noise produced during high-speed rotation, thereby improving the scanning and measurement accuracy of the lidar. The specific features of the components in the rotating device 10 will be described in conjunction with the accompanying drawings below.

As shown in FIG. 1, the rotating device 10 includes a bearing support 1, a motor, and the polygonal mirror 3. The bearing support 1 includes a first bearing support 11 and a second bearing support 12 the oppositely arranged each other. In the present application, the bearing support 1 further includes a base 14. The first bearing support 11 and the second bearing support 12 are arranged in parallel, and are respectively connected to the same end surface of the base 14. The base 14 is provided with a mounting portion (not shown in the figure) to facilitate the installation of the rotating device 10 on the lidar. The base 14 can also be an end surface corresponding to the installation position of the polygonal mirror 3 within the lidar to save material costs when installing the rotating device 10. The polygonal mirror 3 and the motor rotor 21 respectively have a certain gap with the base 14 to ensure smooth rotation of the motor components and the polygonal mirror 3.

In this embodiment, the motor can be an outer rotor permanent magnet synchronous motor with small size and high torque, capable of driving the polygonal mirror 3 to achieve high-speed rotation. The motor is connected to a surface of the first bearing support 11 facing toward the second bearing support 12. An end surface of the motor facing away from the first bearing support 11 is provided with a motor rotor 21. In the present application, the motor further includes a motor base 22. The motor base 22 is connected to an end surface of the motor rotor 21 facing toward the first bearing support 11. The motor is connected to the first bearing support 11 through the motor base 22.

Furthermore, the motor further includes a motor-rotor hub 23. The motor-rotor hub 23 is mounted around an outer periphery of the motor rotor 21 to limit the rotation space of the motor rotor 21 when driven to rotate by the motor. The motor-rotor hub 23 may be in direct contacted or not in direct contacted to the motor rotor 21. Preferably, along an inner wall of the motor-rotor hub 23, a plurality of damping components (not shown in the figure) made of vibration damping material are disposed between the motor-rotor hub 23 and the outer periphery of the motor rotor 21, and the contact between the motor-rotor hub 23 and the motor rotor 21 is achieved through the damping components to further reduce vibration and noise when the motor rotor 21 drives the polygonal mirror 3 to rotate.

It is understandable that the connection relationship between the motor base 22 and the first bearing support 11 can be either that the motor base 22 is detachably connected to the first bearing support 11 to facilitate the disassembly and subsequent maintenance of the rotating device 10, or, according to design requirements of the lidar and the rotating device 10, the motor base 22 and the first bearing support 11 can be integrated to reduce the installation components required for the lidar and the rotating device 10, thereby saving material costs.

In this embodiment, other components in the rotating device 10 can reduce the centrifugal force generated by the motor. Specifically, the polygonal mirror 3 includes a first end surface and a second end surface opposite to the first end surface (the first end surface and the second end surface are not shown in figures). The first end surface is connected to the motor rotor 21 through a plurality of connecting elements 31. A bearing 13 is disposed between the first bearing support 11 and the second bearing support 12. An end of the bearing 13 is connected to the second bearing support 12. The other end thereof passes through the second end surface and the first end surface to connect to the motor, so that the motor rotor 21 and the polygonal mirror 3 are respectively sleeved on the bearing 13. In this application, the position where the other end of the bearing 13 is connected to the motor includes but is not limited to an end surface of the motor base 22 facing the motor rotor 21, an end surface of the motor base 22 away from the motor rotor 21, and positions inside the motor base 22, which are not elaborated here. the motor drives the motor rotor 21 to rotate when operating, thereby driving the bearing 13 to rotate and in turn causing the polygonal mirror 3 to rotate around the bearing 13.

In some feasible embodiments, the other end of the bearing 13 can also pass through the motor base 22 to connect to the first bearing support 11, to further enhance the support of the bearing support 1 to the motor rotor 21, and avoid deviation in the position of the polygonal mirror 3 due to deformation of both ends of the bearing 13 after high-speed rotation, which in turn may cause errors in the light beams emitted by the lidar through the polygonal mirror 3 to the outside, thereby affecting the scanning accuracy and measurement accuracy of the lidar.

In this embodiment, the polygonal mirror 3 is formed by a plurality of mirrors 32 surrounding the edges of the first end surface and the second end surface. Each mirror 32 is connected to an adjacent mirror 32 thereof, and parallel to the bearing 13. The plurality of connecting elements 31 are symmetrically arranged around the bearing 13 to improve the stability of the connection between the motor rotor 21 and the polygonal mirror 3, thereby improving the concentricity of the polygonal mirror 3 relative to the rotating device 10 during rotation. Preferably, the plurality of mirrors 32 are also symmetrically arranged around the bearing 13. The plurality of connecting elements 31 are arranged according to the arrangement direction of the plurality of mirrors 32 in the polygonal mirror 3 to improve the stability of the polygonal mirror 3 in the rotating device 10, thereby maintaining good concentricity of the rotating device 10 during high-speed rotation.

In the above embodiment, the first bearing support 11 and the second bearing support 12, combined with the bearing 13 and the base 14, enhance the support for other components in the rotating device 10, avoiding measurement errors due to deformation of the bearing 13, especially at both ends of the bearing 13, during high-speed rotation of the rotating device 10. In this application, the lidar emits the light beams to the outside through the polygonal mirror 3. The following will elaborate on how the rotating device 10 adjusts itself through the light beams.

In this embodiment, the rotating device 10 further includes an encoder 4. The encoder 4 is located on a surface of the second bearing support 12 facing away from the first bearing support 11. The encoder 4 is configured to generate control instructions based on the light beams and send the control instructions to the motor to adjust operating data of the motor, so that the motor drives the motor rotor 21 to rotate according to the operating data. The operating data includes rotational speed data representing a rotational speed of the motor, and position data representing a rotational position of the motor. The encoder 4 is capable of converting input analog signals and/or digital signals into corresponding output signals and generating corresponding control instructions based on the output signals to feed back to the rotating device 10 of the lidar, thereby controlling the rotation of the polygonal mirror 3. Specifically, the encoder 4 generates output signals based on the beam and/or the spot formed by the beam, or signals corresponding to the beam and/or the spot, and generates control instructions based on the output signals. Correspondingly, in this application, the control instructions can be speed commands for adjusting the rotational speed of the motor. After generating the control instructions, the encoder 4 sends the control instructions to the motor to control the current rotational speed of the motor. In this application, the control instructions can also be position commands for adjusting the rotational position of the motor. After generating the control instructions, the encoder 4 sends the control instructions to the motor to control the current rotational speed and/or rotational position of the motor.

In the above embodiment, it is described how to adjust the rotating device 10 by light beams. When the components within the rotating device 10 in this application rotate at high speeds driven by the motor, corresponding dynamic balancing is required to avoid deviation of the rotating components. The specific implementation of dynamic balancing for the rotating device 10 will be elaborated.

In this embodiment, the rotating device 10 further includes a first dynamic-balance component 5. The first dynamic-balance component 5 is in a cylindrical shape as a whole, and opposite end faces of the first dynamic-balance component 5 have grooves with a certain axial depth to facilitate the installation of the first dynamic-balance component 5 with other components in the rotating device 10, thereby maintaining good concentricity of the rotating device 10 during high-speed rotation. Specifically, the first dynamic-balance component 5 is provided with a first dynamic-balance surface 51 facing toward the first bearing support 11, and a second dynamic-balance surface 52 facing away from the first dynamic-balance surface 51. The first dynamic-balance surface 51 directly contacts an end face of the motor rotor 21 facing toward the second bearing support 12, and the first dynamic-balance surface 51 has a groove with a certain axial depth to facilitate contact between the end face of the motor rotor 21 facing toward the second bearing support 12 and the first dynamic-balance surface 51. Along an axis direction perpendicular to the first dynamic-balance component 5, a cross-sectional area of the first dynamic-balance surface 51 is smaller than a cross-sectional area of the second dynamic-balance surface 52.

Further, to enable the rotating device 10 to maintain dynamic balancing even at high rotational speeds, the rotating device 10 also achieves dynamic balancing of the motor rotor 21 by adding counterweight elements to the first dynamic-balance component 5. Specifically, the first dynamic-balance component 5 further comprises a first sidewall extending toward the second bearing support 12 around the edge of the first dynamic-balance surface 51, a second sidewall extending toward the first bearing support 11 around the edge of the second dynamic-balance surface 52, and a first counterweight groove 53 formed by surrounding the second dynamic-balance surface 52, an outer wall of the first sidewall, and an inner wall of the second sidewall (the first sidewall and the second sidewall are not shown in the figure). The first counterweight groove 53 accommodates a plurality of first counterweight elements (not shown) to achieve dynamic balancing of the rotating device 10 during high-speed rotation. The first counterweight elements can be adapted according to the material of the first counterweight groove 53.

Exemplarily, the material of the first counterweight groove 53 includes but is not limited to photoelectric materials, magneto-electric materials, metallic materials, etc., i.e., the methods for dynamic balancing of the motor rotor 21 include but are not limited to photoelectric methods, magneto-electric methods, weight adjustment methods, etc. Correspondingly, the material of the first counterweight elements includes but is not limited to metals, gels, photoelectric materials, etc.

In this embodiment, based on the dynamic balancing of the motor rotor 21, the rotating device 10 also performs dynamic balancing on the encoder 4 to improve the accuracy of the data input to the encoder 4 and further enhance the precision of the control commands outputted by the encoder 4. Specifically, the rotating device 10 further comprises a second dynamic-balance component 6. The second dynamic-balance component 6 is located on a surface of the second bearing support 12 facing away from the polygonal mirror 3, and there is a certain gap between the second dynamic-balance component 6 and the second bearing support 12. The second dynamic-balance component 6 has a cylindrical shape as a whole. The shapes and/or sizes of the first dynamic-balance component 5 and the second dynamic-balance component 6 can be equal or unequal. The second dynamic-balance component 6 is provided with a third dynamic-balance surface 61 facing toward the second bearing support 12, and a fourth dynamic-balance surface 62 facing away from the third dynamic-balance surface 61. Along an axis direction perpendicular to the second dynamic-balance component 6, a cross-sectional area of the fourth dynamic-balance surface 62 is smaller than that of the third dynamic-balance surface 61.

Further, the third dynamic-balance surface 61 has a groove with a certain axial depth. The encoder 4 achieves dynamic balancing through components on the fourth dynamic-balance surface 62. Specifically, the second dynamic-balance component 6 further comprises a third sidewall extending away from the second bearing support 12 around the edge of the third dynamic-balance surface 61, a fourth sidewall extending toward the second bearing support 12 around the edge of the fourth dynamic-balance surface 62, and a second counterweight groove 63 formed by the fourth dynamic-balance surface 62, an outer wall of the third sidewall, and an inner wall of the fourth sidewall (the third sidewall and the fourth sidewall are not shown in the figures). The second counterweight groove 63 accommodates a plurality of second counterweight elements (not shown) to achieve dynamic balancing of the encoder 4 during high-speed rotation. Since the encoder 4 does not directly contact the second dynamic-balance component 6, preferably, the material of the second counterweight groove 63 can be magneto-electric material. Correspondingly, the material of the second counterweight elements can also be magneto-electric material.

Refer to FIG. 2, a schematic structural diagram of a lidar is illustrated in FIG. 2. The lidar 100 provided includes the polygonal mirror 3 and the rotating device 10. The rotating device 10 has been described in detail earlier and will not be elaborated upon here. The rotating device 10 is configured to enable the lidar 100 to emit light beams externally through the polygonal mirror.

In the above-mentioned embodiment, the rotating device and the lidar achieve connection between the polygonal mirror and the motor rotor through the plurality of connecting elements, which can reduce vibration and noise when the polygonal mirror rotates around the bearing. Moreover, by connecting the bearing to the bearing support and the motor, good concentricity between the motor and the polygonal mirror when the motor driving is ensured. Additionally, brackets capable of accommodating countercounterweight elements are respectively sleeved between two bearing supports and outside the bearing support to reduce the centrifugal force of the polygonal mirror and the rotating device thereof.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this invention and do not therefore limit the patent scope of this invention. And equivalent structure or equivalent process transformation made by the specification and the drawings of this invention, either directly or indirectly applied in other related technical fields, shall be similarly included in the patent protection scope of this invention.

1. A rotating device of a polygonal mirror, applied to a lidar equipped with the polygonal mirror, the rotating device comprising:
a bearing support, comprising a first bearing support and a second bearing support that oppositely arranged each other;
a motor, connected to a surface of the first bearing support facing toward the second bearing support, an end surface of the motor facing away from the first bearing support defining with a motor rotor; and
the polygonal mirror, comprising a first end surface, and a second end surface opposite to the first end surface, the first end surface being connected to the motor rotor through a plurality of connecting elements;
a bearing being disposed between the first bearing support and the second bearing support, an end of the bearing connected to the second bearing support, the other end thereof, passing through the second end surface and the first end surface, being connected to the motor, the motor rotor and the polygonal mirror being respectively sleeved on the bearing; the motor driving the motor rotor to rotate when operating, thereby driving the bearing to rotate and in turn causing the polygonal mirror to rotate around the bearing.

2. The rotating device according to claim 1, wherein the bearing support further comprises a base, the first bearing support and the second bearing support are parallelly arranged, and respectively connected to the same end surface of the base, the polygonal mirror and the motor rotor respectively have a certain gap with the base.

3. The rotating device according to claim 1, wherein the motor further comprises a motor base, the motor base is connected to an end surface of the motor rotor facing toward the first bearing support, the motor base is connected to the first bearing support.

4. The rotating device according to claim 1, wherein the polygonal mirror is formed by a plurality of mirrors surrounding the edges of the first end surface and the second end surface, each mirror is connected to an adjacent mirror thereof, and parallel to the bearing; the plurality of connecting elements are symmetrically arranged around the bearing.

5. The rotating device according to claim 1, wherein the lidar emits light beams to the outside through the polygonal mirror; the rotating device further comprises an encoder located on a surface of the second bearing support facing away from the first bearing support, the encoder is configured to generate control instructions based on the light beams and send the control instructions to the motor to adjust operating data of the motor, so that the motor drives the motor rotor to rotate according to the operating data.

6. The rotating device according to claim 5, wherein the operating data comprises rotational speed data representing a rotational speed of the motor, and position data representing a rotational position of the motor.

7. The rotating device according to claim 1, wherein the rotating device further comprises a first dynamic-balance component, the first dynamic-balance component is provided with a first dynamic-balance surface facing toward the first bearing support, and a second dynamic-balance surface facing away from the first dynamic-balance surface, the first dynamic-balance surface is directly contacted to an end surface of the motor rotor facing toward the second bearing support; along an axis direction perpendicular to the first dynamic-balance component, a cross-sectional area of the first dynamic-balance surface is smaller than a cross-sectional area of the second dynamic-balance surface.

8. The rotating device according to claim 7, wherein the first dynamic-balance component further comprises a first sidewall extending toward the second bearing support around the edge of the first dynamic-balance surface, a second sidewall extending toward the first bearing support around the edge of the second dynamic-balance surface, and a first counterweight groove formed by the second dynamic-balance surface, an outer wall of the first sidewall, and an inner wall of the second sidewall, the first counterweight groove accommodates a plurality of first counterweight elements.

9. The rotating device according to claim 1, wherein the rotating device further comprises a second dynamic-balance component located on a surface of the second bearing support facing away from the polygonal mirror, the second dynamic-balance component has a certain gap with the second bearing support; the second dynamic-balance component is provided with a third dynamic-balance surface facing toward the second bearing support and a fourth dynamic-balance surface facing away from the third dynamic-balance surface; along an axis direction perpendicular to the second dynamic-balance component, a cross-sectional area of the fourth dynamic-balance surface is smaller than a cross-sectional area of the third dynamic-balance surface.

10. The rotating device according to claim 9, wherein the second dynamic-balance component further comprises a third sidewall extending away from the second bearing support around the edge of the third dynamic-balance surface, a fourth sidewall extending toward the second bearing support around the edge of the fourth dynamic-balance surface, and a second counterweight groove formed by the fourth dynamic-balance surface, an outer wall of the third sidewall, and an inner wall of the fourth sidewall, the second counterweight groove accommodates a plurality of second counterweight elements.

11. A lidar, the lidar comprising:
a polygonal mirror; and
a rotating device of a polygonal mirror, configured to enable the lidar to emit light beams to the outside through the polygonal mirror, the rotating device comprising:
a bearing support, comprising a first bearing support and a second bearing support that oppositely arranged each other;
a motor, connected to a surface of the first bearing support facing toward the second bearing support, an end surface of the motor facing away from the first bearing support defining with a motor rotor; and
the polygonal mirror, comprising a first end surface, and a second end surface opposite to the first end surface, the first end surface being connected to the motor rotor through a plurality of connecting elements;
a bearing being disposed between the first bearing support and the second bearing support, an end of the bearing connected to the second bearing support, the other end thereof, passing through the second end surface and the first end surface, being connected to the motor, the motor rotor and the polygonal mirror being respectively sleeved on the bearing; the motor driving the motor rotor to rotate when operating, thereby driving the bearing to rotate and in turn causing the polygonal mirror to rotate around the bearing.

12. The lidar according to claim 11, wherein the bearing support further comprises a base, the first bearing support and the second bearing support are parallelly arranged, and respectively connected to the same end surface of the base, the polygonal mirror and the motor rotor respectively have a certain gap with the base.

13. The lidar according to claim 11, wherein the motor further comprises a motor base, the motor base is connected to an end surface of the motor rotor facing toward the first bearing support, the motor base is connected to the first bearing support.

14. The lidar according to claim 11, wherein the polygonal mirror is formed by a plurality of mirrors surrounding the edges of the first end surface and the second end surface, each mirror is connected to an adjacent mirror thereof, and parallel to the bearing; the plurality of connecting elements are symmetrically arranged around the bearing.

15. The lidar according to claim 11, wherein the lidar emits light beams to the outside through the polygonal mirror; the rotating device further comprises an encoder located on a surface of the second bearing support facing away from the first bearing support, the encoder is configured to generate control instructions based on the light beams and send the control instructions to the motor to adjust operating data of the motor, so that the motor drives the motor rotor to rotate according to the operating data.

16. The lidar according to claim 15, wherein the operating data comprises rotational speed data representing a rotational speed of the motor, and position data representing a rotational position of the motor.

17. The lidar according to claim 11, wherein the rotating device further comprises a first dynamic-balance component, the first dynamic-balance component is provided with a first dynamic-balance surface facing toward the first bearing support, and a second dynamic-balance surface facing away from the first dynamic-balance surface, the first dynamic-balance surface is directly contacted to an end surface of the motor rotor facing toward the second bearing support; along an axis direction perpendicular to the first dynamic-balance component, a cross-sectional area of the first dynamic-balance surface is smaller than a cross-sectional area of the second dynamic-balance surface.

18. The lidar according to claim 17, wherein the first dynamic-balance component further comprises a first sidewall extending toward the second bearing support around the edge of the first dynamic-balance surface, a second sidewall extending toward the first bearing support around the edge of the second dynamic-balance surface, and a first counterweight groove formed by the second dynamic-balance surface, an outer wall of the first sidewall, and an inner wall of the second sidewall, the first counterweight groove accommodates a plurality of first counterweight elements.

19. The lidar according to claim 11, wherein the rotating device further comprises a second dynamic-balance component located on a surface of the second bearing support facing away from the polygonal mirror, the second dynamic-balance component has a certain gap with the second bearing support; the second dynamic-balance component is provided with a third dynamic-balance surface facing toward the second bearing support and a fourth dynamic-balance surface facing away from the third dynamic-balance surface; along an axis direction perpendicular to the second dynamic-balance component, a cross-sectional area of the fourth dynamic-balance surface is smaller than a cross-sectional area of the third dynamic-balance surface.

20. The lidar according to claim 19, wherein the second dynamic-balance component further comprises a third sidewall extending away from the second bearing support around the edge of the third dynamic-balance surface, a fourth sidewall extending toward the second bearing support around the edge of the fourth dynamic-balance surface, and a second counterweight groove formed by the fourth dynamic-balance surface, an outer wall of the third sidewall, and an inner wall of the fourth sidewall, the second counterweight groove accommodates a plurality of second counterweight elements.
